(19) United States
(12) Patent Application Publication
(10) Pub. No.: US 2025/0258109 A1
(43) Pub. Date: Aug. 14, 2025

(54) WIRELESS SENSOR FOR DETECTING ICE-WATER STATE TRANSITION

(71) Applicant: Georgia Tech Research Corporation, Atlanta, GA (US)

(72) Inventors: Ashutosh Dhekne, Atlanta, GA (US); Rahul Bulusu, Atlanta, GA (US)

(21) Appl. No.: 19/054,339

(22) Filed: Feb. 14, 2025

Related U.S. Application Data
(60) Provisional application No. 63/553,214, filed on Feb. 14, 2024.

(51) Int. Cl. G01N 22/00; G05D 23/19

(52) U.S. Cl. CPC G01N 22/00; G05D 23/1917

(57) ABSTRACT

An exemplary sensing and control system and method having receivers configured to detect state-of-matter transition and a controller configured to detect completion of the state-of-matter transition to provide accurate and precise control of refrigeration or thawing of food. Unlike temperature measurements, which remain constant during freezing or thawing, the exemplary system and method evaluate the complex permittivity of matter (e.g., food), which can change throughout the process as evidenced by radio-frequency reflections and is significantly higher for water than ice.

### RELATED APPLICATION

This U.S. application claims priority to, and the benefit of, U.S. Provisional Patent Application No. 63/553,214, filed on Feb. 14, 2024, entitled “Wireless Sensor for detecting Ice-Water state transition,” which is incorporated by reference herein in its entirety.

### GOVERNMENT LICENSED RIGHTS

This invention was made with government support under 2145278, awarded by the National Science Foundation. The government has certain rights in the invention.

### BACKGROUND

Kitchen appliances, refrigeration systems, microwaves, and their commercial and industrial analogs that control the freezing, heating, and thawing cycles of food and ingredients enhance food safety, maintain food quality, and reduce food waste. In kitchens, appliance controllers regulate temperature to prevent bacterial growth and preserve the texture and flavor of food. In grocery stores, temperature controllers keep products fresh and appealing to customers. In the transport industry, trucks are equipped with freezers to maintain a consistent cold chain, prevent spoilage, and comply with regulations. Proper temperature management helps protect health, save money, and minimize environmental impact.

Kitchen appliances (e.g., refrigeration systems, microwaves, freezers) have features that allow for the customized control of the freezing, heating, and thawing operations, e.g., temperature set points, preset timers, or power settings for a set of common foods.

There is nevertheless a benefit to improving the thermal regulation and temperature control of food and foodstuff.

### SUMMARY

An exemplary sensing and control system and method are disclosed that measure and/or detect the state-of-matter transition, transition initiation or competition, or degree/magnitude of change thereof to provide accurate and precise control of the refrigeration or thawing process for food. Unlike temperature measurements, which remain constant during freezing or thawing, the exemplary system and method evaluate the complex permittivity of matter (e.g., food), which can change throughout the process as observable by radio-frequency reflections and is significantly higher for water than ice. In a conventional freezer, when additional food is added to the temperature-controlled space, temperature measurements would remain constant until the food in the freezer has already melted in parts for a change in temperature to be observed. Similarly, when thawing food in a conventional microwave, the microwave would apply energized microwaves to the food for a predefined time or at a preset power level. There is no way to ascertain if there are frozen regions in the thawing of food using temperature measurements without substantially overcooking the food.

The exemplary system and method transmit and receive RF impulse broadcasts to observe changes in the complex permittivity of a physical object (e.g., in a refrigerator, freezer, or microwave) in the path of the RF impulse broadcasts to detect its state-of-matter transition (e.g., as the physical object (e.g., food) thaws, melts, or freezes) to which a controller can determine a period of transition, or state-of-matter preceding the transition (e.g., start of melting or thawing and start of freezing), and following the transition (completion of melting or thawing or competition of freezing).

Thawing and melting is a transition-of-matter transition state for an object (e.g., food, water) from the object's solid state to its liquid state. This process can occur when the temperature rises above the freezing point of the material, causing the molecules in the material to absorb heat and gain enough energy to transition into the liquid state. Thawing can occur in enclosed spaces, including freezers, trucks, ovens, etc.

Freezing is a transition-of-matter transition state from the object's liquid state to its solid state. This process can occur when the temperature drops below the freezing point of the material, causing the molecules in the material to release energy and transition to the solid state. Freezing can occur in enclosed spaces, including freezers, trucks, ovens, etc.

While discussed in the context of food, physical objects may include medication, shipping items, biological samples, articles of manufactures (e.g., in a factory), and other physical objects in which detecting the presence or degree/magnitude of thawing, melting, or freezing is of interest.

In some embodiments, the exemplary system is installed inside a freezer to detect if any physical object inside the freezer is thawing. The wireless receiver (e.g., sensor) can augment temperature measurements at different places in the freezer. The same receiver can also be used in a refrigerator supplement to signal thawing, meaning the food is now suitable for cooking. Furthermore, the same receiver can also be used in microwave ovens to detect if frozen food has thawed. Microwaves are more efficient on water than on ice, and therefore, ovens could use other techniques to thaw food, such as convection warm-air currents, while the food is not yet thawed.

The exemplary system and method can be used for consumer freezers, commercial freezers, e.g., at grocery stores, industrial freezers at warehouses, and in vehicles, e.g., trucks and temporary freezers where food is stored while being transported in the cold supply chain, e.g., to detect the presence of melting/thawing. The exemplary system and method can operate with most food packaging. A single receiver system can monitor a full freezer, whereas a thermometer only provides temperature readings at a specific spot.

The exemplary system and method can be used for microwave ovens where food is being cooked to the presence of non-melted ice or incomplete thawing. The exemplary system and method can operate with most food packaging.

In an aspect, a system is disclosed comprising one or more receivers, including a first receiver, for detecting a state-of-matter transition of a material from a first state-of-matter to a second state-of-matter in an enclosure having surfaces defining a volume for receiving a plurality of physical objects (e.g., food, ice), wherein the first receiver is located in a first region in the enclosure configured to (i) receive a first sensing impulse broadcast transmitted by a first transmitter located in a second region in the enclosure, wherein the first sensing impulse broadcast is reflected off the surfaces and the physical objects in the volume, and (ii) generate an impulse response measurement corresponding to at least a portion of a reflected portion of the first sensing impulse broadcast, wherein the plurality of physical objects has a material property of a first complex permittivity when in the first state-of-matter and a second complex permittivity when in the second state-of-matter, and wherein reflectance of the impulse response has a correspondence to a complex permittivity of the state-of-matter of the material of the physical objects in the volume; and a controller configured to: receive, via the one or more receivers, the impulse response measurement; determine a presence of a transition, or degree thereof, of the state-of-matter of the physical objects from the first state-of-matter and to the second state-of-matter based on a comparison of the received impulse response measurement to a historical profile of the received impulse response measurement; and output an output signal based on the determination, wherein the output signal is used for thermal control or thermal regulation of the volume (and corresponding physical objects located therein).

In some embodiments, the comparison of the received impulse response measurement to the historical profile of the received impulse response measurement comprises determining a similarity value between the received impulse response measurement and the historical profile of the received impulse response measurement; in response to the similarity value exceeding a predefined numerical range, adding the received impulse response measurement to the historical profile of the received impulse response measurement; and in response to the similarity value being within the predefined numerical range without the enclosure being opened, outputting an indicator value or control output corresponding to the presence of a transition.

In some embodiments, the comparison of the received impulse response measurement to the historical profile of the received impulse response measurement comprises determining, in an analog manner, a difference between the received impulse response measurement and the historical profile of the received impulse response measurement using an amplifier; in response to the determined difference falls outside a predefined analog range, adding the received impulse response measurement to the historical profile of the received impulse response measurement; and in response to the determined difference falling within the predefined analog range without the enclosure being opened, outputting an indicator value corresponding to the presence of a transition.

In some embodiments, the similarity value corresponds to a change in the complex permittivity of the physical objects in response to the material property transitioning from the first state-of-matter to the second state-of-matter.

In some embodiments, the similarity value is determined by the received impulse response aligned with the historical profile of the received impulse response measurement.

In some embodiments, the first transmitter is configured to transmit the first sensing impulse broadcast in the volume, and the first sensing impulse broadcast is reflected from the surfaces and the physical objects in the volume.

In some embodiments, the one or more receivers include a second transmitter, wherein the second transmitter is located in a third region in the enclosure and is configured to transmit a second sensing impulse broadcast in the volume, wherein the second sensing impulse broadcast is reflected off the surfaces and the physical objects in the volume.

In some embodiments, the system described herein further comprises a second receiver located in a fourth region in the enclosure configured to (i) receive a second sensing impulse broadcast transmitted by the second transmitter and (ii) generate an impulse response measurement corresponding to at least a portion of a reflected portion of the second sensing impulse broadcast.

In some embodiments, the controller is configured to communicatively operate with a computing device (e.g., phone, cloud infrastructure) as a remote controller.

In some embodiments, the controller is physically coupled to the one or more receivers in a single integrated receiver-controller device.

In some embodiments, the single integrated receiver-controller device is part of a fridge system.

In some embodiments, the single integrated receiver-controller device is part of a microwave system.

In some embodiments, one or more receivers are selected from the group consisting of ultra-wideband transceiver, ultra-wideband receiver, near-field transceiver, near-field receiver, and RFID transceiver.

In some embodiments, the presence of the transition, or degree thereof, of the state-of-matter of the physical objects includes (i) ice starting to melt, (ii) ice having melted completely, (iii) water starting to freeze, or (iv) water being frozen completely.

In another aspect, a method is disclosed comprising receiving, via one or more receivers, an impulse response measurement; determining a presence of a transition, or degree thereof, of a state-of-matter of physical objects from a first state-of-matter and to a second state-of-matter based on a comparison of the received impulse response measurement to a historical profile of the received impulse response measurement; and outputting an output signal based on the determination, wherein the output signal is used for thermal control or thermal regulation of an enclosure having surfaces defining a volume for receiving a plurality of physical objects.

In some embodiments, the method described herein further comprises calculating a similarity value between the received impulse response measurement and the historical profile of the received impulse response measurement using a predefined similarity metric; in response to the similarity value falling outside a predefined numerical range, adding the received impulse response measurement to the historical profile of the received impulse response measurement; and in response to the similarity value falling within the predefined numerical range without the enclosure being opened, outputting an indicator value corresponding to the presence of a transition.

In some embodiments, a system for detecting a state-of-matter transition of a material from a first state-of-matter to a second state-of-matter in an enclosure having surfaces defining a volume for receiving a plurality of physical objects is disclosed, the system comprises one or more transmitters, including a first transmitter, configured to transmit a first sensing impulse broadcast in the volume, wherein the first transmitter being located in a first region in the enclosure, wherein the first sensing impulse broadcast is reflected off the surfaces and the physical objects in the volume; one or more receivers, including a first receiver, for detecting the state-of-matter transition of the material, wherein the first receiver is located in a second region in the enclosure configured to (i) receive the first sensing impulse broadcast, and (ii) generate an impulse response measurement corresponding to at least a portion of a reflected portion of the first sensing impulse broadcast, wherein the plurality of physical objects has a material property of first complex permittivity when in the first state-of-matter and a second complex permittivity when in the second state-of-matter, and wherein reflectance of the impulse response has a correspondence to a complex permittivity of the state-of-matter of the material of the physical objects in the volume; and a controller configured to: receive, via the one or more receivers, the impulse response measurement; determine a presence of a transition, or degree thereof, of the state-of-matter of the physical objects from the first state-of-matter and to the second state-of-matter based on a comparison of the received impulse response measurement to a historical profile of the received impulse response measurement; and output an output signal based on the determination, wherein the output signal is used for thermal control or thermal regulation of the volume (and corresponding physical objects located therein).

In some embodiments, the system described herein further comprises a second transmitter located in a third region in the enclosure configured to transmit the second sensing impulse broadcast in the volume, wherein the second sensing impulse broadcast is reflected off the surfaces and the physical objects in the volume.

In some embodiments, the system described herein further comprises a second receiver located in a fourth region in the enclosure configured to (i) receive a second sensing impulse broadcast transmitted by the second transmitter and (ii) generate an impulse response measurement corresponding to at least a portion of a reflected portion of the second sensing impulse broadcast.

In another aspect, a non-transitory computer-readable medium is disclosed having instructions stored thereon, wherein execution of the instructions by a processor causes the processor to receive, via one or more receivers, an impulse response measurement; determine a presence of a transition, or degree thereof, of a state-of-matter of physical objects from a first state-of-matter and to a second state-of-matter based on a comparison of the received impulse response measurement to a historical profile of the received impulse response measurement; and output an output signal based on the determination, wherein the output signal is used for thermal control or thermal regulation of an enclosure having surfaces defining a volume for receiving a plurality of physical objects.

### BRIEF DESCRIPTION OF DRAWINGS

The accompanying drawings, which are incorporated in and constitute a part of this specification, illustrate embodiments and, together with the description, serve to explain the principles of the methods and systems.

Embodiments of the present invention may be better understood from the following detailed description when read in conjunction with the accompanying drawings. Such embodiments, which are for illustrative purposes only, depict novel and non-obvious aspects of the invention. The drawings include the following figures:

FIGS. 1A-1C each shows an example system configured with one or more receivers, one or more transmitters, and a microcontroller having a memory configured to store a historical profile of impulse response measurements. FIG. 1A employs one receiver, one transmitter, and one microcontroller, wherein the microcontroller is coupled to the receiver and configured to control one temperature control plant. FIG. 1B employs a plurality of receivers, a plurality of transmitters, and the microcontroller, wherein the microcontroller is coupled to one or more receivers and configured to concurrently control two temperature control plants, in accordance with an illustrative embodiment.

FIG. 2 shows an example operation flow for the exemplary system in accordance with an illustrative embodiment.

FIGS. 3A-3D each shows an example Receiver-Transmitter configuration for the exemplary system. FIG. 3A shows a configuration having one receiver and one transmitter located in the same volume. FIG. 3B shows a configuration having two receivers and one transmitter located in the same volume. FIG. 3C shows a configuration having one receiver and two transmitters located in the same volume. FIG. 3D shows a configuration of two transceivers located in the same volume.

FIG. 4 shows an example state-of-matter transition of a physical object (e.g., food, ice) from a solid state-of-matter to a liquid state-of-matter and from a liquid state-of-matter to a solid state-of-matter.

FIG. 5 shows an example algorithm employed by the exemplary system for detecting the state transition of a physical object (e.g., ice, food).

FIGS. 6A-6C show a fabricated wireless sensor system for detecting the state transition of physical objects (e.g., food, ice) and the channel impulse responses (CIRs) (i.e., impulse response measurement) obtained from the fabricated system. FIG. 6A shows the fabricated system placed inside a fridge. FIG. 6B shows the CIRs collected by the fabricated system for ice and water after the ice was completely thawed. FIG. 6C shows the Cumulative Distribution Function (CDF) of similarity scores comparing CIRs (e.g., Water CIR, Ice CIR) to long-term average impulse response (e.g., Water Avg, Ice Avg).

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

### Example System

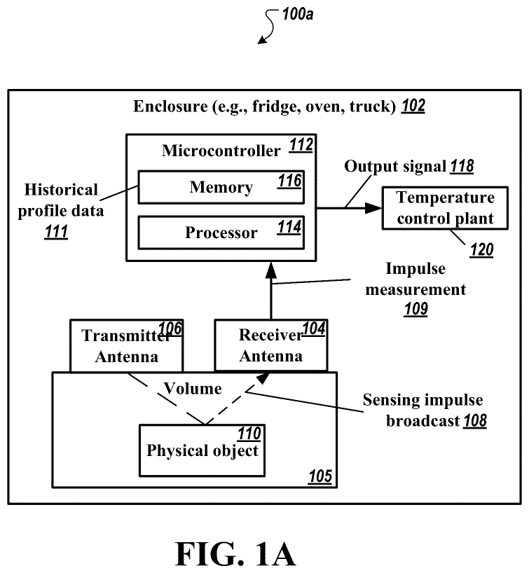

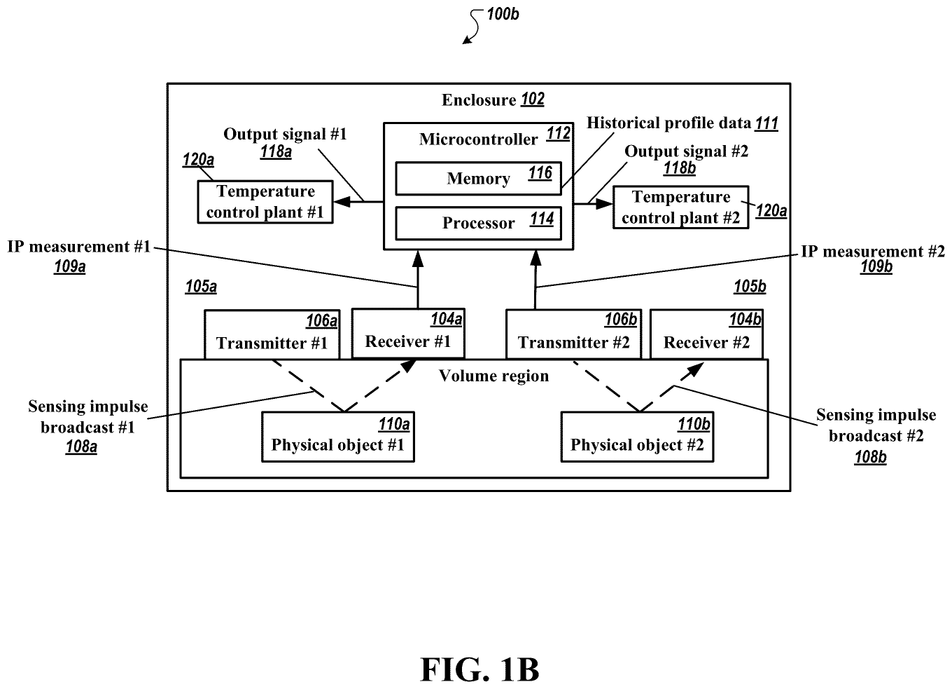

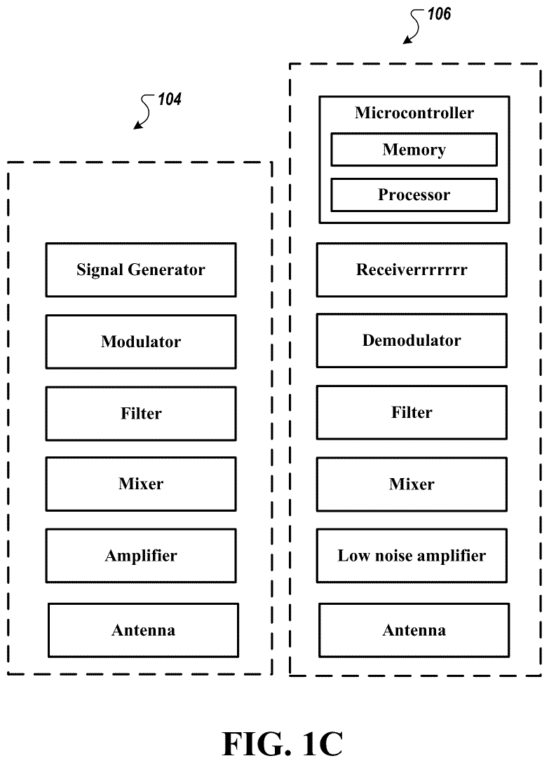

FIGS. 1A-1C each shows an example state-of-matter transition detection system 100 (shown as 100a, 100b) in accordance with an illustrative embodiment. In the examples shown in FIGS. 1A, and 1B, the system 100 is configured with one or more receivers (shown as 104, 104a, 104b), one or more transmitters (shown as 106, 106a, 106b), and a microcontroller 112 having a memory 116 configured to store a historical profile of impulse response measurements (shown as historical profile data 111). FIG. 1A employs a receiver 104, a transmitter 106, and microcontroller 112, wherein the microcontroller 112 is coupled to the receiver 104 and configured to control only one temperature control plant 120. FIG. 1B shows a system comprising a plurality of receivers (e.g., receiver #1 (shown as 104a) and receiver #2 (shown as 104b)), a plurality of transmitters (e.g., transmitter #1 (shown as 106a and transmitter #2 (shown as 106b)), and the microcontroller 112, wherein the microcontroller is coupled to receiver 104a and receiver 104b and configured to control both temperature control plants 120a and 120b (shown as temperature control plant #1 and #2).

Receivers and Transmitters. In the example shown in FIG. 1A, the system 100a comprises the receiver 104 configured to detect a state-of-matter transition of a material from a first state-of-matter to a second state-of-matter in an enclosure 102 having surfaces defining a volume 105 for receiving a physical object 110 (e.g., food, ice). The receiver 104 and transmitter 106 are disposed at different locations of the volume 105, to which locations along the RF path of the transmitter and receiver can be interrogated. The transmitter 106 is configured to transmit a sensing impulse broadcast 108 in the volume 105, and the sensing impulse broadcast is reflected off the surfaces and the physical object 110 in the volume 105.

The receiver 104 is configured to receive the sensing impulse broadcast 108 and generate an impulse response measurement 109 (shown as impulse measurement) corresponding to at least a portion of the reflected portion of the sensing broadcast 108. The receiver 104 can only detect the state-of-matter transition (e.g., from the first state-of-matter state to the second state-of-matter state) when it receives the portion of the reflected portion of the sensing broadcast. The receiver 104 cannot specifically detect the first state-of-matter state or the second state-of-matter state of the physical objects.

In the example shown in FIG. 1B, the system 100b comprises the receivers 104a and 104b, where the receiver 104a is configured to detect the state-of-matter transition of the physical object 110a (shown as physical object #1) from a first state-of-matter to a second state-of-matter in the volume region 105a, and wherein the receiver 104b is configured to detect the state-of-matter transition of the physical object 110b from a first state-of-matter to a second state-of-matter in the same volume region having a temperature gradient with the first region. In the volume region, the receiver 104a and the transmitter 106a are disposed at different locations, e.g., in a left side of the truck/cargo hold, and the receiver 104b and the transmitter 106b are disposed at different locations, e.g., in a right side of the truck/cargo hold. Shipping trucks may be subject to thermal gradients within their payload containers due to the orientation of travel (e.g., north and south) of the truck and the partial exposure of a section of the truck/cargo hold to the sun.

In the example shown in FIG. 1B, the transmitter 106a is configured to transmit the sensing impulse broadcast 108a (shown as sensing impulse broadcast #1) in the volume region 105a, and the sensing impulse broadcast is reflected off the surfaces and the physical object 110a in the volume region 105a. The receiver 104a is configured to receive the sensing impulse broadcast 108a and generate the impulse response measurement 109a (shown as impulse measurement #1) corresponding to at least a portion of the reflected portion of the sensing broadcast 108a.

The transmitter 106b is configured to transmit the sensing impulse broadcast 108b (shown as sensing impulse broadcast #2) in the volume region 105b, and the sensing impulse broadcast is reflected off the surfaces and the physical object 110b in the volume region 105b. The receiver 104b is configured to receive the sensing impulse broadcast 108b and generate the impulse response measurement 109b (shown as impulse measurement #2) corresponding to at least a portion of the reflected portion of the sensing broadcast 108b.

The receivers (e.g., 104, 104a, 104b) can be selected from the group consisting of ultra-wideband transceiver, ultra-wideband receiver, near-field transceiver, near-field receiver, and RFID transceiver.

Microcontroller (i.e., controller). In the example shown in FIG. 1A, the microcontroller 112 can receive the impulse measurement 109 from the receiver 104. The microcontroller 112 then determines, via a processor 114, a presence of a transition, or degree thereof, of the state-of-matter of the physical object 110 from the first state-of-matter and to the second state-of-matter based on a comparison of the received impulse measurement 109 to a historical profile of the received impulse response measurement (shown as historical profile data 111) stored in a memory 116 of the microcontroller 112. The comparison of the received impulse measurement 109 to the historical profile data 111 can comprise (i) determining a similarity value between the received impulse measurement 119 and the historical profile data 111, (ii) in response to the similarity value exceeding a predefined numerical range, adding the received impulse measurement 109 to the historical profile data 111, and (iii) in response to the similarity value being within the predefined numerical range without the enclosure 102 being opened, outputting an indicator value or control output (shown as output signal 118) corresponding to the presence of a transition. The microcontroller 112 then, via the processor 114, outputs the output signal 118 based on the determination of the state-of-matter transition, and the output signal 118 can be transmitted to a temperature control plant 120 for thermal control or thermal regulation of the volume 105 (and corresponding physical object 110 located therein).

In the example shown FIG. 1B, the microcontroller 112 can receive the impulse measurements 109a and 109b from the receivers 104a and 104b and control the temperature of the volume regions 105a and 150b concurrently in real-time.

To control the temperature of volume region 105a, after receiving the impulse measurement 109a, the microcontroller 112 can determine, via the processor 114, the presence of a transition, or degree thereof, of the state-of-matter of the physical object 110a from the first state-of-matter and to the second state-of-matter based on a comparison of the received impulse measurement 109a to the historical profile 111. The comparison of the received impulse measurement 109a to the historical profile data 111 can comprise (i) determining a similarity value between the received impulse measurement 119a and the historical profile data 111, (ii) in response to the similarity value exceeding a predefined numerical range, adding the received impulse measurement 109a to the historical profile data 111, and (iii) in response to the similarity value being within the predefined numerical range without the enclosure 102 being opened, outputting an indicator value or control output (shown as output signal #1, 118a) corresponding to the presence of a transition. The microcontroller 112 then, via the processor 114, outputs the output signal 118a based on the determination of the state-of-matter transition of the object 110a, and the output signal 118a can be transmitted to the temperature control plant 120a for thermal control or thermal regulation of the volume 105a (and corresponding physical object 110a located therein).

To control the temperature of volume region 105b, after receiving the impulse measurement 109b, the microcontroller 112 can determine, via the processor 114, the presence of a transition, or degree thereof, of the state-of-matter of the physical object 110b from the first state-of-matter and to the second state-of-matter based on a comparison of the received impulse measurement 109b to the historical profile 111. The comparison of the received impulse measurement 109b to the historical profile data 111 can comprise (i) determining a similarity value between the received impulse measurement 119b and the historical profile data 111, (ii) in response to the similarity value exceeding a predefined numerical range, adding the received impulse measurement 109b to the historical profile data 111, and (iii) in response to the similarity value being within the predefined numerical range without the enclosure 102 being opened, outputting an indicator value or control output (shown as output signal #2, 118b) corresponding to the presence of a transition. The microcontroller 112 then, via the processor 114, outputs the output signal 118b based on the determination of the state-of-matter transition of the object 110b, and the output signal 118b can be transmitted to the temperature control plant 120b for thermal control or thermal regulation of the volume 105b (and corresponding physical object 110b located therein).

The similarity value can correspond to a change in the complex permittivity of the physical object (e.g., 110, 110a, 110b) in response to the material property transitioning from the first state-of-matter to the second state-of-matter. The similarity value can be determined with the received impulse response aligned with the historical profile data 111.

In some implementations, the microcontroller 112 is configured to communicatively operate with a computing device (e.g., phone, cloud infrastructure) as a remote controller. In other implementations, the microcontroller 112 is physically coupled to the receivers (e.g., 104, 104a, 104b) in a single integrated receiver-controller device, wherein the single integrated receiver-controller device can be part of (i) a fridge system or (ii) a microwave system.

In other implementations, the microcontroller 112 is configured to detect the completion of the state-of-matter transition or the start of the transition, or to the end of the transition.

State-of-matter Transition Detection. FIG. 1C shows an example detector 100a, 100b. In the example shown in FIG. 1C, the receiver 104 and transmitter 106 are separately located. The receiver may include the controller to detect the state-of-matter transition. The transmitter may include a controller or may be connected to the controller of the receiver over a wire.

In the example shown in FIG. 1C, the transmitter (e.g., 106) includes an RF transmitter comprising a signal generator (e.g., oscillator), a modulator circuit, filters, a mixer, a power amplifier, and an antenna. The receiver (e.g., 104) includes a receiver circuit, a demodulator circuit, filters, a de-mixer, a low-noise amplifier, and an antenna.

The controller may be configured, via computer-readable instructions, to execute a detection algorithm, e.g., that aligns a simple similarity metric with a newly obtained CIR by comparing it to a long-term average CIR using the first direct path between the transmitter and the receiver, e.g., the first peak in the CIR. The detection algorithm can then compute the L1 norm (i.e., a vector norm defined as the sum of the absolute values) of the difference between the two CIRs. A low L1 norm can indicate high similarity, while a high L1 norm can indicate low similarity between the current CIR and the long-term average.

### Example Method

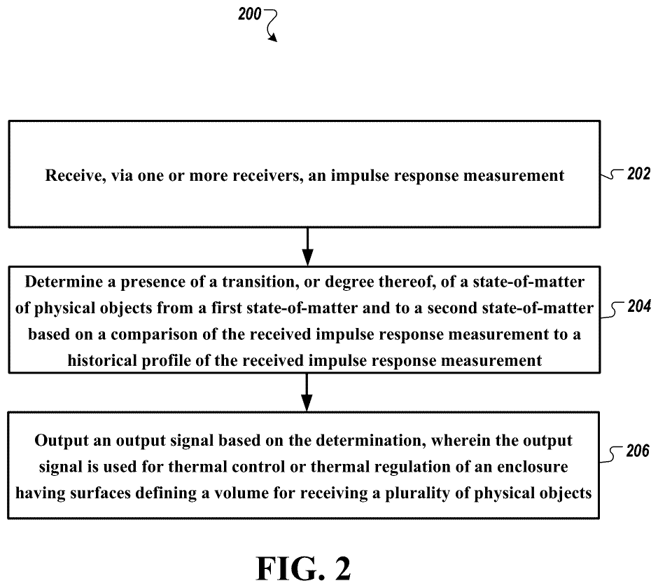

FIG. 2 shows an example operation flow 200 for the exemplary system, which can comprise 3 steps. At step 202, the exemplary system can receive, via one or more receivers, an impulse response measurement. At step 204, the exemplary system can determine a presence of a transition, or degree thereof, of a state-of-matter of physical objects from a first state-of-matter and to a second state-of-matter based on a comparison of the received impulse response measurement to a historical profile of the received impulse response measurement. At step 206, the exemplary system can output an output signal based on the determination, wherein the output signal is used for thermal control or thermal regulation of an enclosure having surfaces defining a volume for receiving a plurality of physical objects.

### Example Receiver and Transmitter Configurations

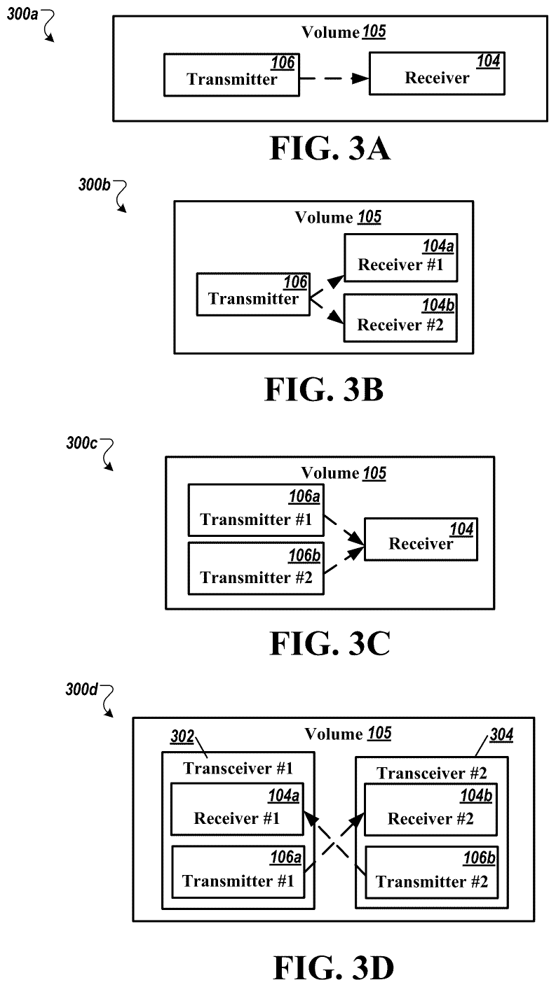

FIGS. 3A-3D each shows an example Receiver-Transmitter configuration for the exemplary system. FIG. 3A shows a configuration 300a having one receiver 104 and one transmitter 106 located in the volume 105. The transmitter 106 can transmit a sensing impulse broadcast (not shown) in the volume 105 and the sensing broadcast can be reflected off the surfaces and the physical objects (not shown) in the volume 105. The receiver 104 can receive the sensing impulse broadcast and generate an impulse response measurement (not shown) corresponding to at least a portion of the reflected portion of the sensing impulse broadcast.

FIG. 3B shows a configuration 300b having two receivers 104a and 104b and one transmitter 106 located in the volume 105. The transmitter 106 can transmit a sensing impulse broadcast in the volume 105 and the sensing broadcast can be reflected off the surfaces and the physical objects in the volume 105. Each receiver 104a and 104b can receive the sensing impulse broadcast and generate a respective impulse response measurement corresponding to at least a portion of the reflected portion of the sensing impulse broadcast.

FIG. 3C shows a configuration 300c having one receiver 104 and two transmitters 106a and 106b located in the volume 105. Each transmitter 106a and 106b can transmit a respective sensing impulse broadcast in the volume 105 and the respective sensing broadcast can be reflected off the surfaces and the physical objects in the volume 105. The receiver 104 can receive the respective sensing impulse broadcast (from transmitters 106a and 106b) and generate impulse response measurements corresponding to at least a portion of the reflected portion of the sensing impulse broadcasts.

FIG. 3D shows a configuration 300d having two transceivers 302 and 304 located in the volume 105, wherein the transceiver 302 comprises a receiver 104a and a transmitter 106a, and wherein the transceiver 304 comprises a receiver 104b and a transmitter 106b. Each transmitter 106a and 106b can transmit a respective sensing impulse broadcast in the volume 105 and the respective sensing broadcast can be reflected off the surfaces and the physical objects in the volume 105. Each receiver 104a and 104b can receive the respective sensing impulse broadcasts and generate respective impulse response measurements corresponding to at least a portion of the reflected portion of the sensing impulse broadcasts.

### Example State-of-Matter Transition

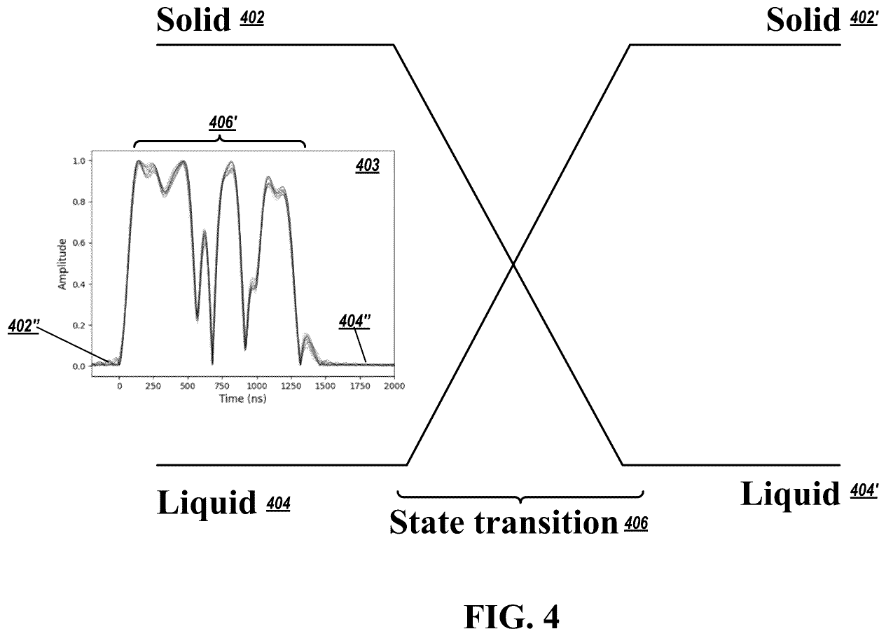

FIG. 4 shows an example state-of-matter transition of a physical object (e.g., food, ice). In FIG. 4, the solid state-of-matter 402 (shown as 402′, 402″) has higher complex permittivity than the liquid state-of-matter 404 (shown as 404′, 404″). The physical object can transition from the solid state-of-matter 402 (shown as 402′, 402″) to the liquid state-of-matter 404′ (shown as 404, 404″), or from the liquid state-of-matter 404 to the solid state-of-matter 402′.

At either solid state-of-matter 402 or liquid state-of-matter 404, the waveform 403 of the state-of-matter remains stable (e.g., flatlined) (shown in 402″ and 404″). The waveform 403 of the state-of-matter shows spikes 406′ only when the physical object is in the state transition 406 (shown as 406′).

In each of these scenarios, the controller may be configured to align a simple similarity metric by comparing a newly obtained CIR with a long-term average CIR using the first direct path between the transmitter and the receiver, e.g., the first peak in the CIR. The controller can then compute the L1 norm (i.e., a vector norm defined as a sum of the absolute values) of the difference in the two CIRs. A low L1 norm can indicate high similarity, while a high L1 norm can indicate low similarity between the current CIR and the long-term average.

### Example Wireless Sensor System for Detecting Ice-Water State Transition

In some implementations, the exemplary system can comprise an ultra-wideband (UWB) transmitter and receiver placed within a small, enclosed space. The exemplary system can employ an algorithm to detect the state transition.

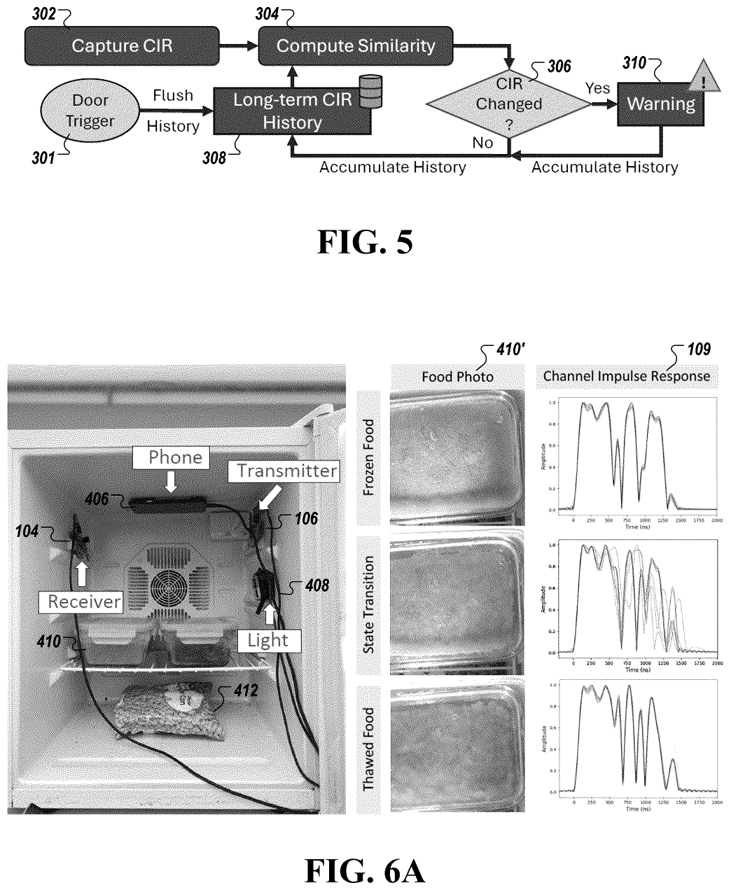

FIG. 5 shows an example algorithm, employed by the exemplary system, for detecting the state-of-matter transition of a physical object (e.g., ice, food). As shown, at step 302, the transmitter sends UWB packets received by the receiver and analyzed in terms of the signal reflections (as obtained from channel impulse response (CIR), shown as 109 in FIGS. 1A-1B). At step 306, if the enclosed space remains undisturbed and the materials continue to remain in their original state, either frozen or thawed, every newly obtained CIR matches the long-term average. At step 308, the receiver builds a history of the obtained CIRs, computing a long-term average.

At step 304, a simple similarity metric is used that aligns the newly obtained CIR with the long-term average CIR using the first direct path between the transmitter and the receiver, represented by the first peak in the CIR. The exemplary system then computes the L1 norm (i.e., vector norm defined as a sum of the absolute value) of the difference in the two CIRs. A low L1 norm can indicate high similarity, while a high L1 norm can indicate low similarity between the current CIR and the long-term average.

A low similarity indicates something has changed from the previous average. An enclosure may have a switch that triggers, at step 301, whenever the enclosure is opened, indicating new food is being added or removed from the enclosure. Such an event triggers the elimination of the previous long-term average and the re-computation of a new average CIR.

At step 306, a state transition is identified if the similarity drops without a trigger from the door-open event. A warning indicator is displayed when a state transition is detected, as shown at step 310. Subsequent CIRs may also mismatch with the long-term average and with each other as state transition progresses.

Finally, when the entire material has transitioned into a new state, consecutive CIRs start to match with one another once again and form a new long-term average, as shown at step 308. The time the long-term history is calculated is a tunable parameter, depending on the exact application space.

Wireless Signals from the Transmitter

Propagation of signal. When a transmitter emits wireless signals (i.e., signal pulse), they spread in all directions, with some fraction arriving directly at a nearby receiver, while most bounce off various obstacles and reflectors in the vicinity before arriving at the receiver. If the wireless signal is an impulse, the time-domain representation of the delayed arrival of these signals may describe the response of the wireless channel to the transmitted impulses. This power-delay profile is called the channel impulse response (CIR). Ultra-wideband (UWB) radios can be used in the exemplary system to transmit raised cosine pulses specified by the IEEE 802.15.4z [3] standard and compute the CIR from the received signal. The wireless reflections experienced by the UWB signals are subject to the placement or location of various materials in the vicinity and the signal's physical interactions with the material. During the solid-liquid state transition, the physical properties of the material undergo changes that affect the reflection and absorption of signals. As a result, the obtained CIR also changes; detecting these changes forms the basis of the wireless sensor.

Primer on Complex Permittivity. The complex permittivity of a material describes the interaction of electromagnetic signals with materials, which can be defined per Equation 1.

$${ϵ}^{*} = {ϵ}^{′} - j {ϵ}^{′′} \qquad ( Eq . 1 )$$

In Equation 1, the real part E′, representing the material's ability to store electrical energy, and the imaginary part ϵ″, indicating energy dissipation, are both critical in understanding how electromagnetic waves are affected by materials [1], [4]. During the thawing process, the ice-water transition may change ϵ′, affecting signal propagation.

Interaction of wireless signals with material. When a traveling wave encounters a material, only a fraction of its energy penetrates the material, called the transmittance of the substance. This fraction, denoted as tΣ, relates to the intrinsic impedance of the abutting materials as defined per Equation 2.

$${t}_{E} = \frac{2 {Z}_{2}}{{Z}_{1} + {Z}_{2}} \qquad ( Eq . 2 )$$

In Equation 2, Z₁ and Z₂ are the intrinsic impedances to the leaving and entering of materials, respectively. The intrinsic impedance is dependent on the material's complex permittivity (denoted as ϵ*), defined per Equation 3

$${Z}^{*} = \frac{{Z}_{0}}{\sqrt{{ϵ}^{*}}} \qquad ( Eq . 3 )$$

In Equation 3, Z₀ is the impedance of free space.

If the complex permittivity of a substance changes, so does the signal's ability to penetrate and reflect from the substance. The solid-liquid state transition of water can cause a substantial change in its complex permittivity, affecting water-based beverages and substances that contain substantial amounts of water, covering a vast majority of food items. This causes wireless signals to reflect differently, detecting thawing and freezing and the transition in between.

### Adapting the Exemplary System in Diverse Applications

To generalize the applicability of the exemplary system to different freezer enclosures and material configurations, (i) the variations in freezer volume and internal configuration, (ii) material and properties, and (iii) distribution of water/ice within food should be considered.

Variations in Freezer Volume and Internal Configuration. Larger enclosures may introduce additional signal reflections and multipath effects, requiring recalibration of the similarity metric to handle more complex CIR profiles. The placement of objects (e.g., shelves, containers) can also affect reflections. Adaptive filtering or dynamic modeling techniques could mitigate such challenges in future implementations.

Enclosure material and properties. The material of the freezer (e.g., metal, plastic, or cardboard) may influence UWB signal propagation. Metal enhances signal confinement (and is preferred), while plastic and cardboard may permit signal leakage and external influence.

Distribution of water/ice within food. Foods with uneven water distribution (e.g., mixed vegetables) exhibit variable thawing patterns. Addressing these variations may further improve the generalization of the exemplary system.

### Experimental Results and Additional Examples

A study was conducted to fabricate the exemplary system and evaluate its performance in distinguishing between water's solid and liquid states inside enclosed spaces (e.g., freezers, microwave ovens).

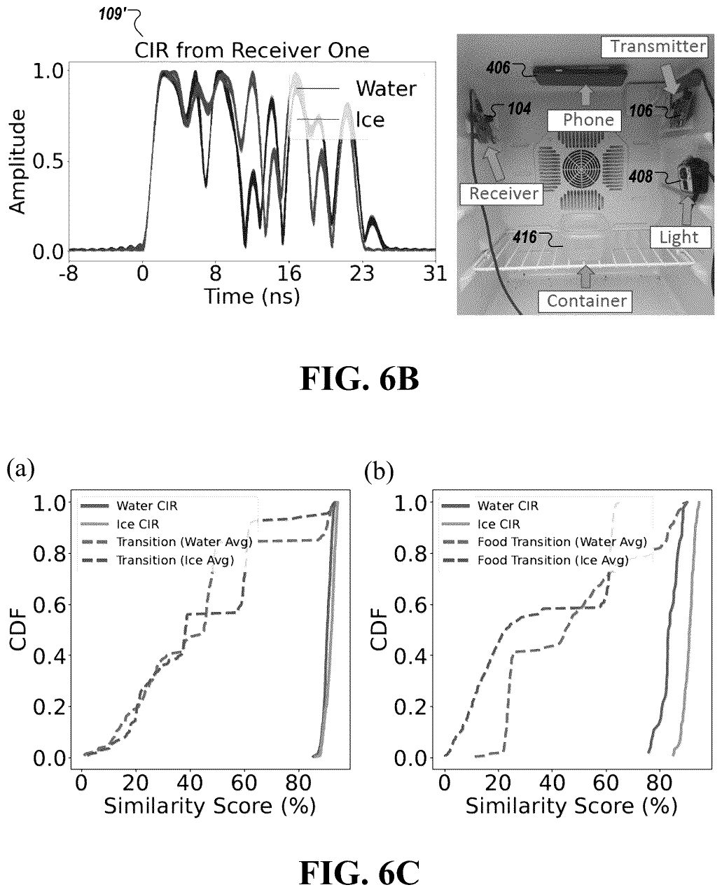

In the study, the fabricated system was low-cost (e.g., less than $50) and required minimal processing power. FIG. 6A shows the fabricated system placed inside a volume of a fridge. As shown, two UWB devices (e.g., receiver 104, transmitter 106), each using a DWM1000 UWB module [12], [13], controlled by a Cortex MO processor [14], were installed in the fridge, with the receiver 104's data sent via USB cable to a Dell Laptop for processing in Python (not shown). The study observed the thawing of the food 410 (shown as 410′) placed inside the fridge using a phone camera 406, and a dedicated, always-on light 408 lighted up the food 410.

The study evaluated the fabricated system by recording (i) the thawing of a block of ice (shown as 416 in FIG. 6B) and (ii) the thawing of food (shown as 410 in FIG. 6A) in glass containers and a bag of corn (shown as 412 in FIG. 6A), all kept in the fridge. First, the study investigated the feasibility of detecting state transitions by checking the stability of the CIRs for fully frozen and fully liquid states, followed by the results from a similarity metric.

Stability of channel impulse response (CIR) in an enclosed space. The channel impulse response (CIR) (shown as 109 in FIG. 6A and 109′ in FIG. 6B), as observed by the UWB device 104 inside the closed container, e.g., a refrigerator or a microwave oven, was stable over time, so long as there were no changes to the contents of the enclosed space.

FIG. 6B shows the CIRs 109′ collected by the fabricated system for ice and water after the ice 416 was completely thawed. In FIG. 6B, all the CIRs 109′ obtained during any one state overlapped with each other, meaning that the UWB signals experienced similar reflection and refraction patterns for both states. The study observed similar stability when food was introduced in the fridge, but did not include the graph for brevity. The freezer was an enclosed metal box, and various external movements (e.g., the researcher moving around in the lab) did not influence the observed CIR 109′ inside the enclosed container.

Similarity indices. The Cumulative Distribution Function (CDF) quantified the distribution of similarity scores across different experimental states, including frozen, thawed, and transitioning. The similarity score was computed as the L1 norm of the difference between the newly observed CIR and the long-term average CIR, normalized and max-subtracted.

FIG. 6C shows the Cumulative Distribution Function (CDF) of similarity scores comparing channel impulse responses (CIRs) (e.g., Water CIR, Ice CIR) to long-term average impulse response (shown as historical profile data 111 in FIGS. 1A-1B) (e.g., Water Avg, Ice Avg). Each plot in FIG. 6C was built from similarity scores calculated for multiple CIR samples collected during the experiments. Specifically, (i) for the frozen state, the study computed the similarity score of all frozen-state CIRs against their respective frozen-state long-term average; (ii) for the thawed state, the study compared all thawed-state CIRs against the thawed-state long-term average; and (iii) for the transition state, the study calculated similarity scores against both frozen and thawed long-term averages, leading to lower similarity values.

Sufficient data was required to compute stable long-term averages to ensure accurate similarity analysis. Table 1 shows the data collection process in the study.

TABLE 1

| Type of | |
|---|---|
| data | How to collect |
| Frozen | A minimum of 100 CIR samples, collected over 10 minutes, |
| state | were used to establish the frozen-state long-term average. |
| Thawed | An equivalent number of CIR samples were collected post- |
| state | transition to compute the thawed-state average. |
| Transition | Continuous CIR sampling (over 20-30 minutes) was |
| state | performed to detect deviations from the initial frozen-state |
| | average. |

Providing these thresholds ensured accuracy in similarity analysis while minimizing false positives caused by environmental disturbances. However, the rate of CIR collection and the stable CIR collection duration can be tuned based on application needs.

Observing state transition as a similarity score. The study used an L1 norm of the difference between the CIR and the long-term average to detect state transition. The study overlapped the long-term average CIR with the current CIR and computed a per-tap difference. The summation of this difference was small for CIRs that were similar to each other, while large when the CIRs had a significant mismatch. A normalized max-subtracted score was then computed.

The study differed from the one-page poster [2], where the promise of this method was showcased. The study focused on state transition and, as such, was interested in determining when recently obtained CIR data started to diverge from the long-term average observed previously. The study, therefore, devised a simplistic similarity metric to aid this comparison. In FIG. 6C, subpanel (a), all CIRs during the ice state produced a high similarity score with the ice long-term average. A similar consistency was observed for water as well. During the transition, however, the similarity score dropped, differing from the ice average and the water average. Depending on the kind of food and homogeneity, some temporal stability may be observed where the CIR remains similar during the transition, most likely when only a small amount of ice remained stuck to the container as thawing occurred from the sides.

Observing state transition for food. Frozen food showed behavior similar to that observed in the study for pure ice-water transition. In FIG. 6C, subpanel (b) shows the similarity CDF for the frozen and fully thawed food and the lower similarity score when the thawing process was underway.

### DISCUSSION

Discussion #1. At microwave frequencies, the solid-liquid state transition of water causes a change in its complex permittivity, and therefore, a corresponding drastic change is also observed in its refractive index (RI). While water has a refractive index of about 8.9, ice has a refractive index of 1.8 at these frequencies [1]. In contrast, for visible light, the refractive index does not change when ice (RI=1.31) transitions into water (RI=1.33). Because most food has substantial amounts of water, this change in permittivity is also observed when food freezes or thaws. In an enclosed space, as in a microwave oven or freezer, where the influence of the external environment is minimal, the changing refractive index changes the wireless signal's reflection and absorption patterns. Wireless reflections show a stable albeit different pattern for frozen and fully thawed foodstuff, but a changing reflection pattern is observed while thawing or freezing is underway.

Developing a wireless sensor that detects the solid-liquid transition can impact the frozen food industry and the transportation industry that uses refrigerated trucks to transport them (called the cold chain). Freezers are monitored using thermometers, which are only a proxy for ensuring that food remains frozen. Temperature differentials, blocking of cold-air vents, different additives in foodstuff that change the melting point, external heat sources, or other variable factors can affect the temperature in different zones, meaning that thermometers alone are not enough to ensure that the food remains frozen. When cooking food, ensuring that the food is fully thawed is important for maintaining both food taste and texture. Further, consuming food within a specific time after it is thawed is important for food safety as it brings a significant health risk if not properly consumed. Microwave ovens are particularly inefficient (due to the lower complex permittivity) when heating frozen foods, while convection heaters would be more efficient. In a different application, both microwaves and freezers have a defrost mode. Understanding when food has fully thawed in a microwave and when the surface frost has been removed from the freezer can be useful for next-generation smart freezers and microwaves. Overall, there is utility in developing a solid-liquid state transition sensor.

A state transition detector that can work through food packaging does not exist. Opportunities for determining state are few. Density changes, changes in form, or changes in conformance of food may all require direct access to the food. However, most food is inside some form of packaging, which can be rigid and provide enough space for expanding food as it freezes, meaning observing the packaging for changes is not enough. Further, infrared thermometers, which can detect differences in temperature over a specific area, may only provide information about the external temperature of the packaging. Thus, inaccessible food makes the state transition detection a difficult problem. In contrast, microwave-range frequencies can penetrate through most packaging materials such as paper, cardboard, plastics, and glass, directly interacting with the food through the packaging. Additionally, since the complex permittivity varies between ice and water, the signal reflection also changes as the food undergoes state transition.

The exemplary system may include a similarity score-based state-transition detection methodology without touching the food and even when the food is placed in an unstructured manner inside an enclosed space.

Discussion #2. The study demonstrated the application of UWB wireless signals in detecting the ice-water transition in food items without direct contact. The experimental setup and implementation, employing low-cost and off-the-shelf devices, validate the feasibility of the exemplary system in real-world scenarios. The stability of the CIR and the distinct signal patterns associated with different states of water in the food show the effectiveness of the exemplary system. The study showed a promise for improving food safety protocols, optimizing cooking and thawing processes, and transforming the monitoring practices within the frozen food and cold-chain logistics industries. Future studies may focus on refining the system for commercial or household use and exploring its application in use cases beyond the freezer, including microwave ovens, traditional ovens, thawing trays, or industrial conveyor belts where food is cooled down to freeze it or warmed up to thaw it for further processing. Further refinements may be required for broader applicability to diverse enclosures and packaging materials (e.g., metal, cardboard).

### CONCLUSION

Computer-executable instructions, such as program modules, being executed by a computer may be used. Generally, program modules include routines, programs, objects, components, data structures, etc., that perform particular tasks or implement particular abstract data types. In its most basic configuration, the controller includes at least one processing unit and memory. Depending on the exact configuration and type of computing device, memory may be volatile (such as random-access memory (RAM)), non-volatile (such as read-only memory (ROM), flash memory, etc.), or some combination of the two. The controller may have additional features/functionality.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited but rather may be implemented in connection with any computing environment, such as a network or distributed computing environment. Still further, aspects of the presently disclosed subject matter may be implemented in or across a plurality of processing chips or devices, and storage may similarly be implemented across a plurality of devices. Such devices might include personal computers, network servers, handheld devices, and wearable devices, for example.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.
[1] V. H. A. R., Dielectrics and waves. Wiley, 1954.
[2] R. Bulusu and A. Dhekne, “Thaw: A uwb-based ice-water state detector,” in Proceedings of the 25th International Workshop on Mobile Computing Systems and Applications, 2024.
[3] J. A. Gutierrez, E. H. Callaway, and R. L. Barrett, IEEE 802.15.4 Low-Rate Wireless Personal Area Networks: Enabling Wireless Sensor Networks. IEEE, 2003.
[4] A. Dhekne, M. Gowda, Y. Zhao, H. Hassanieh, and R. R. Choudhury, “Liquid: A wireless liquid identifier,” in Proceedings of the 16th Annual International Conference on Mobile Systems, Applications and Services (MobiSys), 2018, pp. 442-454.
[5] F. Villa-Gonzalez, R. Bhattacharyya, T. Athauda, S. E. Sarma, and N. C. Karmakar, “Detecting breaks in cold chain integrity using chipless rfid time-temperature sensors,” in IEEE Sensors Journal, vol. 22, no. 18, 2022.
[6] U. Ha, J. Leng, A. Khaddaj, and F. Adib, “Food and liquid sensing in practical environments using RFIDs,” in 17th USENIX Symposium on Networked Systems Design and Implementation (NSDI 20), 2020, pp. 1083-1100.
[7] S. S. K. S. P. Woskov, “Real-time non-contact millimeter wave characterization of water-freezing and ice-melting dynamics,” in Journal of Infrared, Millimeter, and Terahertz Waves, vol. 30, no. 4, 2009.
[8] C. Li, F. Li, W. Du, L. Yin, B. Wang, C. Wang, and T. Luo, “A material identification approach based on wi-fi signal,” Computers, Materials & Continua, vol. 69, pp. 3383-3397, 2021.
[9] B. Xie, J. Xiong, X. Chen, E. Chai, L. Li, Z. Tang, and D. Fang, “Tagtag: material sensing with commodity rfid,” in Proceedings of the 27th ACM Conference on Embedded Networked Sensor Systems, 2019.
[10] J. Wang, J. Xiong, X. Chen, H. Jiang, R. K. Balan, and D. Fang, “Tagscan: Simultaneous target imaging and material identification with commodity rfid devices,” in Proceedings of the 23rd Annual International Conference on Mobile Computing and Networking, 2017.
[11] S. Changede and A. Dhekne, “Intrusense: an enhanced physical security system using uwb,” in Proceedings of the 23rd Annual International Workshop on Mobile Computing Systems and Applications, 2022, pp. 41-47.
[12] M. McLaughlin and B. Verso, “Asymmetric double-sided two-way ranging in an uwb communication system,” Feb. 14 2016.
[13] “Decawave dwm1000 user manual,” 2017.
[14] Y. Cao, A. Dhekne, and M. Ammar, “6fit-a-part: A protocol for physical distancing on a custom wearable device,” in 2020 IEEE 28th International Conference on Network Protocols (ICNP).

1. A system comprising:
one or more receivers, including a first receiver, for detecting a state-of-matter transition of a material from a first state-of-matter to a second state-of-matter in an enclosure having surfaces defining a volume for receiving a plurality of physical objects, wherein the first receiver is located in a first region in the enclosure configured to (i) receive a first sensing impulse broadcast transmitted by a first transmitter located in a second region in the enclosure, wherein the first sensing impulse broadcast is reflected off the surfaces and the physical objects in the volume, and (ii) generate an impulse response measurement corresponding to at least a portion of a reflected portion of the first sensing impulse broadcast, wherein the plurality of physical objects has a material property of a first complex permittivity when in the first state-of-matter and a second complex permittivity when in the second state-of-matter, and wherein reflectance of the impulse response has a correspondence to a complex permittivity of the state-of-matter of the material of the physical objects in the volume; and
a controller configured to:
receive, via the one or more receivers, the impulse response measurement;
determine a presence of a transition, transition initiation or completion, or degree thereof, of the state-of-matter of the physical objects from the first state-of-matter and to the second state-of-matter based on a comparison of the received impulse response measurement to a historical profile of the received impulse response measurement; and
output an output signal based on the determination, wherein the output signal is used for thermal control or thermal regulation of the volume.

2. The system of claim 1, wherein the comparison of the received impulse response measurement to the historical profile of the received impulse response measurement comprising:
determining a similarity value between the received impulse response measurement and the historical profile of the received impulse response measurement;
in response to the similarity value exceeding a predefined numerical range, adding the received impulse response measurement to the historical profile of the received impulse response measurement; and
in response to the similarity value being within the predefined numerical range without the enclosure being opened, outputting an indicator value or control output corresponding to the presence of a transition.

3. The system of claim 1, wherein the comparison of the received impulse response measurement to the historical profile of the received impulse response measurement comprising:
determining, in an analog manner, a difference between the received impulse response measurement and the historical profile of the received impulse response measurement using an amplifier;
in response to the determined difference falling outside a predefined analog range, adding the received impulse response measurement to the historical profile of the received impulse response measurement; and
in response to the determined difference falling within the predefined analog range without the enclosure being opened, outputting an indicator value corresponding to the presence of a transition.

4. The system of claim 2, wherein the similarity value corresponds to a change in complex permittivity of the physical objects in response to the material property transitioning from the first state-of-matter to the second state-of-matter.

5. The system of claim 2, wherein the similarity value is determined with the received impulse response aligned with the historical profile of the received impulse response measurement.

6. The system of claim 1, wherein the first transmitter is configured to transmit the first sensing impulse broadcast in the volume, and wherein the first sensing impulse broadcast is reflected from the surfaces and the physical objects in the volume.

7. The system of claim 1, wherein the one or more receivers include a second transmitter, wherein the second transmitter is located in a third region in the enclosure and is configured to transmit a second sensing impulse broadcast in the volume, wherein the second sensing impulse broadcast is reflected off the surfaces and the physical objects in the volume.

8. The system of claim 9 further comprising:
a second receiver located in a fourth region in the enclosure configured to (i) receive a second sensing impulse broadcast transmitted by the second transmitter and (ii) generate an impulse response measurement corresponding to at least a portion of a reflected portion of the second sensing impulse broadcast.

9. The system of claim 1, wherein the controller is configured to communicatively operate with a computing device as a remote controller.

10. The system of claim 1, wherein the controller is physically coupled to the one or more receivers in a single integrated receiver-controller device.

11. The system of claim 10, wherein the single integrated receiver-controller device is part of a fridge system.

12. The system of claim 10, wherein the single integrated receiver-controller device is part of a microwave system.

13. The system of claim 1, wherein one or more receivers are selected from the group consisting of ultra-wideband transceiver, ultra-wideband receiver, near-field transceiver, near-field receiver, and RFID transceiver.

14. The system of claim 1, the presence of the transition, or degree thereof, of the state-of-matter of the physical objects includes (i) ice starting to melt, (ii) ice having melted completely, (iii) water starting to freeze, or (iv) water being frozen completely.

15. A method comprising:
receiving, via one or more receivers, an impulse response measurement;
determining a presence of a transition, or degree thereof, of a state-of-matter of physical objects from a first state-of-matter and to a second state-of-matter based on a comparison of the received impulse response measurement to a historical profile of the received impulse response measurement; and
outputting an output signal based on the determination, wherein the output signal is used for thermal control or thermal regulation of an enclosure having surfaces defining a volume for receiving a plurality of physical objects.

16. The method of claim 15 further comprising:
calculating a similarity value between the received impulse response measurement and the historical profile of the received impulse response measurement using a predefined similarity metric;
in response to the similarity value falling outside a predefined numerical range, adding the received impulse response measurement to the historical profile of the received impulse response measurement; and
in response to the similarity value falling within the predefined numerical range without the enclosure being opened, outputting an indicator value corresponding to the presence of a transition.

17. A system for detecting a state-of-matter transition of a material from a first state-of-matter to a second state-of-matter in an enclosure having surfaces defining a volume for receiving a plurality of physical objects, the system comprising:
one or more transmitters, including a first transmitter, configured to transmit a first sensing impulse broadcast in the volume, wherein the first transmitter being located in a first region in the enclosure, wherein the first sensing impulse broadcast is reflected off the surfaces and the physical objects in the volume;
one or more receivers, including a first receiver, for detecting the state-of-matter transition of the material, wherein the first receiver is located in a second region in the enclosure configured to (i) receive the first sensing impulse broadcast, and (ii) generate an impulse response measurement corresponding to at least a portion of a reflected portion of the first sensing impulse broadcast, wherein the plurality of physical objects has a material property of first complex permittivity when in the first state-of-matter and a second complex permittivity when in the second state-of-matter, and wherein reflectance of the impulse response has a correspondence to a complex permittivity of the state-of-matter of the material of the physical objects in the volume; and
a controller configured to:
receive, via the one or more receivers, the impulse response measurement;
determine a presence of a transition, state, or degree thereof, of the state-of-matter of the physical objects from the first state-of-matter and to the second state-of-matter based on a comparison of the received impulse response measurement to a historical profile of the received impulse response measurement; and
output an output signal based on the determination, wherein the output signal is used for thermal control or thermal regulation of the volume.

18. The system of claim 17 further comprising:
a second transmitter located in a third region in the enclosure configured to transmit the second sensing impulse broadcast in the volume, wherein the second sensing impulse broadcast is reflected off the surfaces and the physical objects in the volume.

19. The system of claim 17 further comprising:
a second receiver located in a fourth region in the enclosure configured to (i) receive a second sensing impulse broadcast transmitted by the second transmitter and (ii) generate an impulse response measurement corresponding to at least a portion of a reflected portion of the second sensing impulse broadcast.

20. (canceled)
